(19) United States
(12) Patent Application Publication
(10) Pub. No.: US 2026/0171432 A1
(43) Pub. Date: Jun. 18, 2026

(54) ELECTROCHEMICAL CELL STACK AND POROUS CONDUCTOR FOR ELECTROCHEMICAL DEVICE

(71) Applicant: SAMSUNG ELECTRO-MECHANICS CO., LTD., Suwon-si (KR)

(72) Inventors: Tae Jun Choi, Suwon-si (KR); Guh Hwan Lim, Suwon-si (KR); Sun Il Jeong, Suwon-si (KR); Hae Sol Jung, Suwon-si (KR); Byung Chul Jang, Suwon-si (KR); Dong In Jeong, Suwon-si (KR)

(73) Assignee: SAMSUNG ELECTRO-MECHANICS CO., LTD., Suwon-si (KR)

(21) Appl. No.: 19/406,361

(22) Filed: Dec. 2, 2025

(30) Foreign Application Priority Data
Dec. 12, 2024 (KR) 10-2024-0184736

(51) Int. Cl. H01M 8/0232; C25B 9/65; H01M 8/0245; H01M 8/10

(52) U.S. Cl. CPC H01M 8/0232; C25B 9/65; H01M 8/0245; H01M 2008/1095

(57) ABSTRACT

An electrochemical cell stack including: first and second separators; an electrochemical cell disposed between the first and second separators; and a porous conductor disposed on at least one side of the electrochemical cell, wherein the porous conductor includes a metal mesh and a porous metal body formed within pores of the metal mesh.

### CROSS-REFERENCE TO RELATED APPLICATION(S)

This application claims benefit of priority to Korean Patent Application No. 10-2024-0184736 filed on Dec. 12, 2024 in the Korean Intellectual Property Office, the disclosure of which is incorporated herein by reference in its entirety.

### TECHNICAL FIELD

The present disclosure relates to an electrochemical cell stack and a porous conductor for an electrochemical device.

An electrochemical device includes a fuel cell generating electrical energy by electrochemically reacting fuel (hydrogen) and an oxidizer (pure oxygen or oxygen in the air), and an electrolytic cell generating hydrogen and oxygen through the electrolysis of water.

As examples of such an electrochemical device, a polymer electrolyte membrane fuel cell (PEMFC) and a polymer electrolyte membrane water electrolysis cell (PEMEC) are attracting attention as an eco-friendly energy source device using hydrogen due to the high efficiency and capacity for miniaturization thereof.

A polymer electrolyte membrane fuel cell and a polymer electrolyte membrane water electrolysis cell typically include a membrane-electrode assembly (MEA) in which a polymer electrolyte membrane is disposed between catalyst electrodes. In addition, a solid oxide fuel cell (SOFC) and a solid oxide electrolysis cell (SOEC) include a cell comprised of an air electrode, a fuel electrode, and a solid electrolyte having oxygen ion conductivity, and the cell may be referred to as a solid oxide cell. A solid oxide cell produces electrical energy through an electrochemical reaction or produces hydrogen by electrolyzing water in a reverse reaction of the solid oxide fuel cell. In addition thereto, other types of fuel cells or electrolytic cells, such as a phosphoric acid fuel cell (PAFC), an alkaline fuel cell (AFC), and a direct methanol fuel cell (DMFC), are also used as a type of electrochemical device.

In the case of an electrochemical device, the electrochemical device is commonly used as a stack structure in which a unit cell is disposed between a pair of separators. In such a stack structure, excellent oxidation resistance and corrosion resistance are required so that the electrochemical cell can be operated stably. In addition, a fuel cell and an electrolytic cell require a design of a stack structure considering a flow of fuel and fluid.

### SUMMARY

An aspect of the present disclosure is to provide an electrochemical cell stack having excellent durability.

According to an aspect of the present disclosure, provided is an electrochemical cell stack, the electrochemical cell stack including: first and second separators; an electrochemical cell disposed between the first and second separators; and a porous conductor disposed on at least one side of the electrochemical cell, wherein the porous conductor includes a metal mesh that includes pores, and a porous metal body within the pores of the metal mesh.

In an embodiment, at least one separator selected from the first and second separators may be free of a flow path.

In an embodiment, the metal mesh may further include metal fibers arranged in a first direction and a second direction that is different from the first direction.

In an embodiment, when a direction perpendicular to the first and second directions is referred to as a third direction, based on the third direction, a first side of the metal mesh may not be covered by the porous metal body, and a second side of the metal mesh may be covered by the porous metal body.

In an embodiment, the first side of the metal mesh is adjacent to at least one separator selected from the first and second separators and the second side of the metal mesh is adjacent to the electrochemical cell.

In an embodiment, when a direction perpendicular to the first and second directions is referred to as a third direction, based on the third direction, opposing sides of the metal mesh are covered by the porous metal body.

In an embodiment, a protective layer coated on a surface of the porous conductor may be further included.

In an embodiment, the protective layer may include Pt.

In an embodiment, a protective layer may be coated on opposing surfaces of the porous conductor.

Meanwhile, according to another aspect of the present disclosure, provided is a porous conductor for an electrochemical device,
the porous conductor for an electrochemical device including a metal mesh that includes pores, and a porous metal body within the pores of the metal mesh.

In an embodiment, each of the metal mesh and the porous metal body may include Ti.

In an embodiment, the metal mesh and the porous metal body may be bonded to each other.

In an embodiment, the metal mesh may further include metal fibers arranged in a first direction and a second direction that is different from the first direction.

In an embodiment, the metal mesh may include a lattice structure, and the lattice structure may include the metal fibers.

In an embodiment, the first direction and the second direction may be perpendicular to each other.

In an embodiment, when a direction perpendicular to the first and second directions is referred to as a third direction, based on the third direction, both sides of the metal mesh may be covered by the porous metal body.

In an embodiment, when a direction perpendicular to the first and second directions is referred to as a third direction, based on the third direction, a first side of the metal mesh may not be covered by the porous metal body, and a second side of the metal mesh may be covered by the porous metal body.

In an embodiment, the porous metal body may be a sintered body of metal particles.

In an embodiment, a porosity of the metal mesh may be higher than a porosity of the porous metal body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a cross-sectional view schematically illustrating an electrochemical cell stack according to an embodiment of the present disclosure;

FIG. 2 is a cross-sectional view illustrating an example of a porous conductor that can be included in an electrochemical cell stack;

FIG. 3 is a plan view illustrating a metal mesh of a porous conductor;

FIG. 4 is a cross-sectional view illustrating a modified example of a porous conductor that can be included in an electrochemical cell stack;

FIG. 5 is a cross-sectional view illustrating a modified example of a porous conductor that can be included in an electrochemical cell stack;

FIG. 6 is a cross-sectional view illustrating an example of a separator that can be included in an electrochemical cell stack;

FIG. 7 is an enlarged cross-sectional view of an example of an electrochemical cell; and

FIG. 8 is an enlarged view of a portion of FIG. 7.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

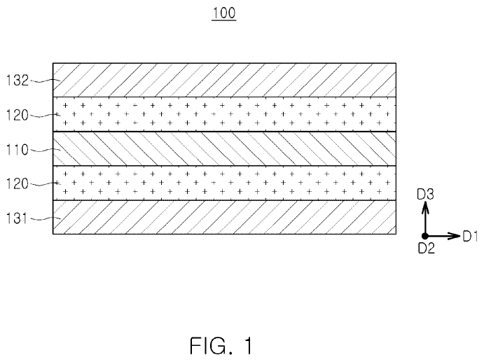

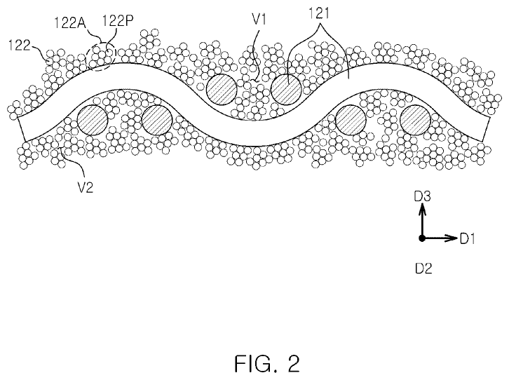

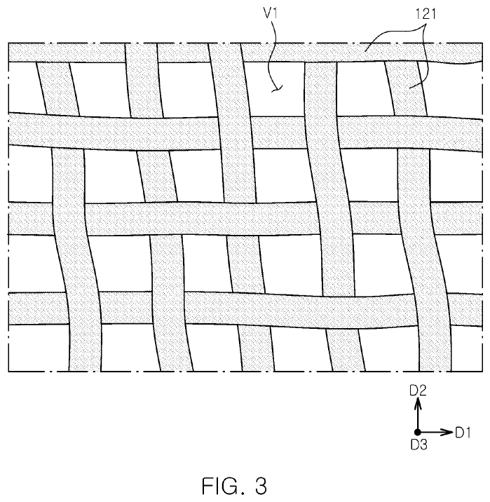

FIG. 1 is a cross-sectional view schematically illustrating an electrochemical cell stack according to an embodiment of the present disclosure. FIG. 2 is a cross-sectional view illustrating an example of a porous conductor that can be included in an electrochemical cell stack. FIG. 3 is a plan view illustrating a metal mesh of a porous conductor.

Referring to FIGS. 1 to 3, an electrochemical cell stack 100 according to an embodiment of the present disclosure includes a first separator 131, a second separator 132, an electrochemical cell 110, and a porous conductor 120 as main components, and the porous conductor 120 includes a metal mesh 121 and a porous metal body 122. Here, the porous metal body 122 of the porous conductor 120 is formed within pores V1 of the metal mesh 121. As in the present embodiment, when using a porous conductor 120 having a composite structure including a metal mesh 121 and a porous metal body 122, porosity of the porous conductor 120 may be effectively controlled at a high level while securing durability of the porous conductor 120. In addition, while increasing the porosity in this manner, electrical connectivity thereof with the electrochemical cell 110, or the like may also be sufficiently maintained. The electrochemical cell stack 100 may be stacked in plural numbers and used as an electrochemical device. Hereinafter, components of the electrochemical cell stack 100 are described.

The first separator 131 and the second separator 132 may be bipolar plates connecting the electrochemical cells in series. The first separator 131 and the second separator 132 may include a metal having a high melting point so as not to be melted or softened at high temperatures when the electrochemical cell 110 is operated and excellent corrosion resistance. For example, the first separator 131 and the second separator 132 may include Ti as an example of a material having excellent acid resistance, oxidation resistance, and voltage resistance characteristics. When the first separator 131 and the second separator 132 having excellent durability are used in PEMEC and PEMFC, they can contribute to improving reliability. However, when the first and second separators 131 and 132 are implemented using a metal including Ti, workability may be relatively poor, and especially when forming a flow path, as the thickness increases, manufacturing costs of the first and second separators 131 and 132 may increase. In addition, there is a possibility that the electrochemical cell, or the like may be deformed during a pressurization process due to the flow path of the first and second separators 131 and 132.

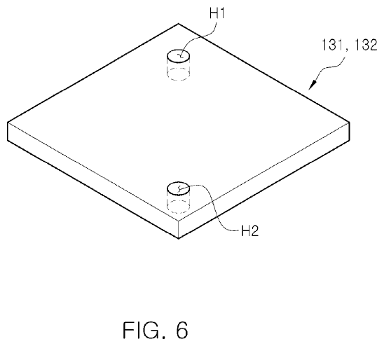

In the present embodiment, by employing a porous conductor 120 between the separators 131 and 132 and the electrochemical cell 110, the first and second separators 131 and 132 may be implemented thinly without a flow path, and thus, process efficiency and durability may be improved. As described above, the first and second separators 131 and 132 may be provided as flat plates without a flow path, and in this case, the first and second separators 131 and 132 may be formed thinly, so that an amount of raw material (e.g., Ti) used to manufacture the first and second separators 131 and 132 may be reduced, while contributing to miniaturization of the electrochemical cell stack 100. When the type of the flow path used in the conventional separators is not used, as illustrated in FIG. 6, the first and second separators 131 and 132 may be provided with one or more through-holes H1 and H2 through which a fluid may move and be in contact with the electrochemical cell 110. In other words, the first and second separators 131 and 132 do not have a flow path, which means that there are no partitions or fluid passages formed along surfaces of the first and second separators 131 and 132, and there may be through-holes H1 and H2 penetrating the first and second separators 131 and 132.

The porous conductor 120 is disposed on at least one side of the electrochemical cell 110, and in FIG. 1, it corresponds to a structure in which the porous conductor 120 is disposed on both sides of the electrochemical cell 110. However, the porous conductor 120 may be disposed on only at least one side of the electrochemical cell 110. The porous conductor 120 may provide an electrical and fluid flow path between the separators 131 and 132 and the electrochemical cell 110. For example, when the electrochemical cell stack 100 is used as a PEMEC, a supply of water may be facilitated through the porous conductor 120. As described above, the porous conductor 120 includes a metal mesh 121 and a porous metal body 122 formed within the pores V1 of the metal mesh 121. The metal mesh 121 and the porous metal body 122 may include Ti, respectively, and when the metal mesh 121 and the porous metal body 122 are connected to each other, they may form an integral structure.

Referring to FIGS. 2 and 3, the metal mesh 121 may have metal fibers arranged in different first directions D1 and second directions D2. Here, the first direction D1 and the second direction D2 may be perpendicular to each other, and a third direction D3 may be perpendicular to each of the first and second directions D1 and D2. By such an arrangement method, a lattice structure may be formed by the metal fibers of the metal mesh 121. The pores V1 of the metal mesh 121 may function as a path through which a fluid such as water flows and may also be used as a path for electric current to flow. In addition, the metal mesh 121 may be structurally stable so that the mechanical strength of the porous conductor 120 may be secured. Meanwhile, a diameter of the metal mesh 121 may be about 80 to 100 μm, and a distance between the metal fibers may be about 200 to 300 μm. In addition, the number of stacked layers of metal fibers in the metal mesh 121 may be two or more than that illustrated in FIG. 2.

The porous metal body 122 is formed within the pores V1 of the metal mesh 121. The porous metal body 122 may include an aggregate 122A of metal particles 122P. In the case of such a structure, the porous metal body 122 may be obtained by sintering metal particles including Ti, or the like, at high temperatures. As illustrated in the form of FIG. 2, the porous metal body 122 includes pores V2, and the overall porosity and electrical conductivity of the porous conductor 120 may be controlled by the porous metal body 122. In this case, the porosity of the metal mesh 121 may be higher than the porosity of the porous metal body 122. In addition, the metal mesh 121 and the porous metal body 122 may be bonded to each other by diffusion bonding, or the like during a heat treatment process at high temperatures, and such a structure may be advantageous in terms of lowering the electrical resistance of the porous conductor 120. The porosity may be obtained from an analysis of an optical micrograph and/or an electron micrograph the porous conductor 120. Other methods and/or tools appreciated by one of ordinary skill in the art, even if not described in the present disclosure, may also be used.

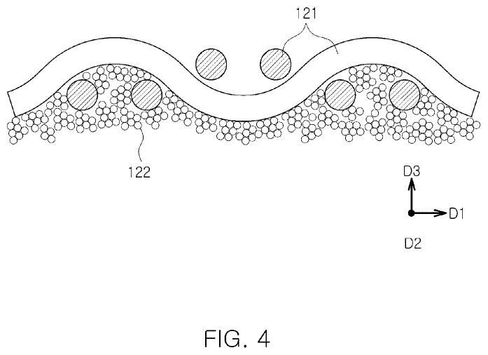

In addition to being formed within the pores V1 of the metal mesh 121, the porous metal body 122 may also be disposed on the outside of the metal mesh 121. Specifically, as illustrated in the form illustrated in FIG. 2, both sides of the metal mesh 121 may be covered by the porous metal body 122 based on the third direction D3. Since both sides of the metal mesh 121 are covered by the porous metal body 122, the electrical resistance may be reduced between the separators 131 and 132 or the electrochemical cell 110. Alternatively, as in the modified example of FIG. 4, the porous metal body 122 may be disposed only on one side of the metal mesh 121. Specifically, based on the third direction D3, one side (upper direction based on the drawings) of the metal mesh 121 may be exposed and not covered by the porous metal body 122, and the other side (lower direction based on the drawings) of the metal mesh 121 may be covered by the porous metal body 122. In this case, the porous conductor 120 may be disposed so that one side (upper direction based on the drawings) of the metal mesh 121 is adjacent to at least one of the first and second separators 131 and 132 and the other side (lower direction based on the drawings) is adjacent to the electrochemical cell 110. In the case of such an asymmetric structure, the advantages in which the supply of fluid such as water may be facilitated in a region adjacent to the separators 131 and 132, and the contact resistance may be reduced and the number of reaction regions may be increased in a region adjacent to the electrochemical cell 110, may be provided.

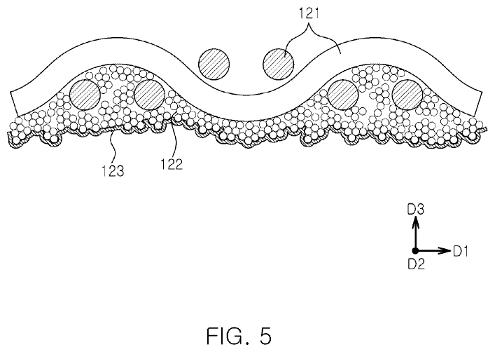

As another modified example, a protective layer 123 coated on a surface of the porous conductor 120 may be further included, as illustrated in FIG. 5. The protective layer 123 may be coated on the surface of the porous conductor 120 to protect the porous conductor 120 by lowering the reactivity of the porous conductor 120 when the electrochemical cell 110 is operated. Considering such functions, the protective layer 123 may include Pt. In particular, when the electrochemical cell stack 100 is used as a PEMEC, the components are required to have high acid resistance and corrosion resistance due to an acidic environment. The electrical characteristics and durability of the porous conductor 120 may be improved through the protective layer 123 including Pt. In the case of a region in which such a protective layer 123 is formed, it can be formed in a region adjacent to a metal oxide cell. In FIG. 5, an example in which the protective layer 123 is formed on the surface of the porous metal body 122 is illustrated, but the protective layer 123 may also be formed on the surface of the metal mesh 121. In addition, in FIG. 5, the protective layer 123 may be formed on only one side of the porous conductor 120, but the protective layer 123 may also be formed on both sides of the porous conductor 120.

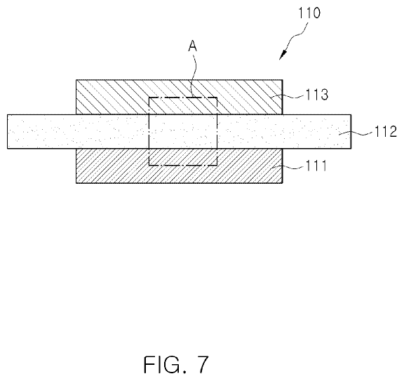

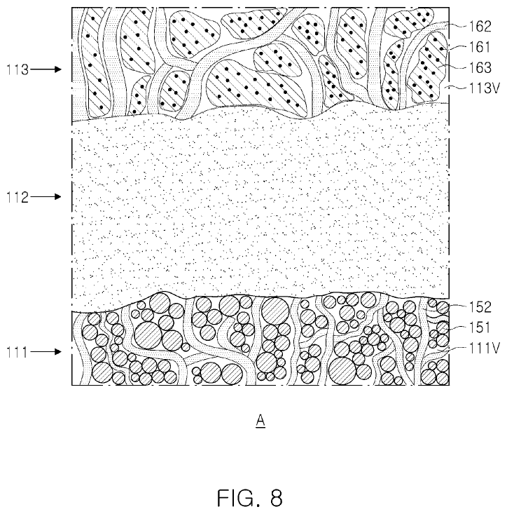

The electrochemical cell 110 may function as a fuel cell or a water electrolysis cell, and as an example, may be a membrane-electrode assembly that may be used in a PEMFC and PEMEC. Hereinafter, the case in which the electrochemical cell 110 is a membrane-electrode assembly will be described, but the electrochemical cell 110 may also be another type of electrochemical cell, such as a solid oxide cell. Referring to FIGS. 7 and 8, the electrochemical cell 110 includes a first catalyst electrode 111, a polymer electrolyte membrane 112, and a second catalyst electrode 113, wherein the polymer electrolyte membrane 112 is disposed between the first and second catalyst electrodes 111 and 113. The first catalyst electrode 111 includes a first catalyst 151, and may include an aggregate of first catalyst 151 particles, as illustrated. In addition to the first catalyst 151, the first catalyst 151 may include an ion conductor 152, and the ion conductor 152 may function as a binder for the first catalyst 151. In addition, pores 111V may be formed within the first catalyst electrode 111 so that gas, liquid, or the like, may move smoothly. The first catalyst 151 is active in the oxygen generation reaction, and may include an Ir-based, Ru-based, or Ti-based material. The ion conductor 152 may provide a moving path for hydrogen ions, or the like, generated from the first catalyst electrode 111, and may include, for example, a fluorine-based ionomer, a carbon-hydrogen-based ionomer, and a mixture thereof. As a specific example, the ion conductor 152 may include a perfluorinated sulfonic acid ionomer. In the case of a water electrolysis cell, the first catalyst electrode 111 is an anode, and water supplied thereto may be separated into oxygen (O₂), hydrogen ions (H⁺, Proton), and electrons. Here, the hydrogen ions may move to the second catalyst electrode 113 through the polymer electrolyte membrane 112, and the electrons may move to the second catalyst electrode 113 through an external circuit and a power supply. When the porous conductor 120 described above has an asymmetrical structure as illustrated in FIG. 4, the porous metal body 122 may be disposed adjacent to the first catalyst electrode 111. However, depending on the embodiment, the first catalyst electrode 111 may be a cathode electrode.

The polymer electrolyte membrane 112 may include an ion conductor to provide a moving path for hydrogen ions, or the like. Here, the ion conductor of the polymer electrolyte membrane 112 may include, for example, a fluorine-based ionomer, a carbon-hydrogen-based ionomer, and a mixture thereof. As a specific example, the ion conductor may include a perfluorinated sulfonic acid ionomer. In the case of a water electrolysis cell, hydrogen ions generated at the first catalyst electrode 111 may move to the second catalyst electrode 113 through the polymer electrolyte membrane 112.

The second catalyst electrode 113 includes a second catalyst 161, and is disposed on the polymer electrolyte membrane 112. In this case, the second catalyst 161 may be provided in a form supported on a support 163, as illustrated. In addition, the second catalyst electrode 113 may include an ion conductor 162, and the ion conductor 162 may function as a binder for the second catalyst 161 and the support 163. In addition, pores 113V may be formed within the second catalyst electrode 113 so that gas, liquid, or the like, may move smoothly. The second catalyst 161 is active in a hydrogen oxidation reaction or oxygen reduction reaction, and may include platinum (Pt), gold (Au), ruthenium (Ru), osmium (Os), palladium (Pd), and alloys thereof. The ion conductor 162 may provide a moving path for hydrogen ions, or the like, and may include, for example, a fluorine-based ionomer, a carbon-hydrogen-based ionomer, and a mixture thereof. As a specific example, the ion conductor 162 may include a perfluorinated sulfonic acid ionomer. The support 163 may be formed as a porous body having a high surface area so as to be able to support a large amount of the second catalyst 161, and for example, a carbon-based support may be used. In the case of a water electrolysis cell, the second catalyst electrode 113 is a cathode, and hydrogen ions supplied through the polymer electrolyte membrane 112 may react with electrons to generate hydrogen. However, depending on the embodiment, the second catalyst electrode 113 may be an anode electrode.

As set forth above, according to an embodiment of the present disclosure, in the case of an electrochemical cell stack, durability, or the like, may be improved. Accordingly, when such an electrochemical cell stack is used as a fuel cell or a water electrolysis cell, performance may be improved.

While example embodiments have been shown and described above, it will be apparent to those skilled in the art that modifications and variations could be made without departing from the scope of the present invention as defined by the appended claims.

What is claimed is:

1. An electrochemical cell stack, comprising:
first and second separators;
an electrochemical cell disposed between the first and second separators; and
a porous conductor disposed on at least one side of the electrochemical cell,
wherein the porous conductor includes:
a metal mesh that includes pores, and
a porous metal body within the pores of the metal mesh.

2. The electrochemical cell stack of claim 1, wherein at least one separator selected from the first and second separators is free of a flow path.

3. The electrochemical cell stack of claim 1, wherein the metal mesh further includes metal fibers arranged in a first direction and a second direction that is different from the first direction.

4. The electrochemical cell stack of claim 3, wherein when a direction perpendicular to the first and second directions is referred to as a third direction,
based on the third direction, a first side of the metal mesh is not covered by the porous metal body, and a second side of the metal mesh is covered by the porous metal body.

5. The electrochemical cell stack of claim 4, wherein the first side of the metal mesh is adjacent to at least one separator selected from the first and second separators and the second side of the metal mesh is adjacent to the electrochemical cell.

6. The electrochemical cell stack of claim 3, wherein when a direction perpendicular to the first and second directions is referred to as a third direction,
based on the third direction, opposing sides of the metal mesh are covered by the porous metal body.

7. The electrochemical cell stack of claim 1, further comprising:
a protective layer coated on a surface of the porous conductor.

8. The electrochemical cell stack of claim 7, wherein the protective layer includes Pt.

9. The electrochemical cell stack of claim 1, further comprising:
a protective layer coated on opposing surfaces of the porous conductor.

10. A porous conductor for an electrochemical device, comprising:
a metal mesh that includes pores; and
a porous metal body within the pores of the metal mesh.

11. The porous conductor for an electrochemical device of claim 10, wherein each of the metal mesh and the porous metal body includes Ti.

12. The porous conductor for an electrochemical device of claim 10, wherein the metal mesh and the porous metal body are bonded to each other.

13. The porous conductor for an electrochemical device of claim 10, wherein the metal mesh further includes metal fibers arranged in a first direction and a second direction that is different from the first direction.

14. The porous conductor for an electrochemical device of claim 13, wherein the metal mesh includes a lattice structure, and the lattice structure includes the metal fibers.

15. The porous conductor for an electrochemical device of claim 13, wherein the first direction and the second direction are perpendicular to each other.

16. The porous conductor for an electrochemical device of claim 13, wherein when a direction perpendicular to the first and second directions is referred to as a third direction,
based on the third direction, both sides of the metal mesh are covered by the porous metal body.

17. The porous conductor for an electrochemical device of claim 13, wherein when a direction perpendicular to the first and second directions is referred to as a third direction,
based on the third direction, a first side of the metal mesh is not covered by the porous metal body, and a second side of the metal mesh is covered by the porous metal body.

18. The porous conductor for an electrochemical cell device of claim 10, wherein the porous metal body is a sintered body of metal particles.

19. The porous conductor for an electrochemical device of claim 10, wherein a porosity of the metal mesh is higher than a porosity of the porous metal body.
